(19) United States
(12) Patent Application Publication
(10) Pub. No.: US 2026/0241753 A1
(43) Pub. Date: Aug. 20, 2026

(54) TIRE

(71) Applicant: The Yokohama Rubber Co., LTD., Kanagawa (JP)

(72) Inventor: Shunya HIDANO, Kanagawa (JP)

(21) Appl. No.: 19/540,014

(22) Filed: Feb. 13, 2026

(30) Foreign Application Priority Data
Feb. 17, 2025 (JP) 2025-023433

(51) Int. Cl. B60C 11/03

(52) U.S. Cl. CPC B60C 11/0302

(57) ABSTRACT

A tire includes: in a tread, main grooves; a center portion between the outermost main grooves; narrow grooves having a width narrower than the main grooves; center land portions defined by the main and narrow grooves; center land portion width direction narrow grooves, side by side in the circumferential direction, each having ends opening to the main and narrow grooves , angles of each changing and openings facing each other with the narrow grooves as boundaries relative to a center of the narrow grooves, and each having a width narrower than the main grooves; and in the center land portions a chamfered portion is disposed from a groove opening of the narrow grooves to a groove opening of the width direction narrow grooves at a low-angle side of an angle formed by the width direction narrow grooves whose openings face each other.

### CROSS-REFERENCE TO RELATED APPLICATION

This application claims priority pursuant to 35 U.S.C. 119(a) to Japanese Patent Application No. 2025-023433, filed February 17, 2025, which application is incorporated herein by reference in its entirety.

### TECHNICAL FIELD

The technology relates to a tire.

### BACKGROUND ART

For example, Japan Unexamined Patent Publication No. 2012-020714 A discloses a heavy duty pneumatic tire having a configuration in which a pair of circumferential main grooves extending in a tire circumferential direction are disposed in a tread surface with a tire equatorial plane interposed therebetween to divide the tread surface into a central region and both side regions, at least one circumferential narrow groove extending in the tire circumferential direction is disposed in the central region to define at least two central rib-like land portions, and openings of the circumferential narrow groove are closed during ground contact, allowing the central rib-like land portions located adjacent to each other with the circumferential narrow groove interposed therebetween to contact and support each other.

As a method for improving rolling resistance, a centering pattern is applied in which main grooves in a center portion are formed as narrow grooves in order to reduce deformation of center blocks having a high ground contact pressure. However, this centering pattern causes the narrow grooves to be closed in a ground contact region of the center portion during ground contact, failing to have a sufficient groove volume and thus degrading wet performance.

### SUMMARY

The technology provide a tire that can provide improved low rolling resistance and wet performance.

A tire according to one aspect of the present technology includes: in a tread surface, at least two circumferential main grooves extending in a tire circumferential direction; a center portion defined between the circumferential main grooves each located on an outermost side in a tire width direction; in the center portion, circumferential narrow grooves disposed extending in the tire circumferential direction and each having a groove width narrower than those of the circumferential main grooves; in the center portion, center land portions defined by the circumferential main grooves and the circumferential narrow grooves; in each of the center land portions, a plurality of width direction narrow grooves that are arranged side by side in the tire circumferential direction, each have both ends in the tire width direction opening to the circumferential main grooves and the circumferential narrow grooves, are disposed changing an angle of each of the width direction narrow grooves whose openings face each other with the circumferential narrow grooves as boundaries with respect to a center line of each of the circumferential narrow grooves, and each have a groove width narrower than those of the circumferential main grooves; and in each of the center land portions, a chamfered portion disposed from at least one side of a groove opening portion of each of the circumferential narrow grooves to a groove opening portion of each of the width direction narrow grooves at a low-angle side of an angle formed by the width direction narrow grooves whose openings face each other with the circumferential narrow groove as boundaries.

According to the technology, low rolling resistance and wet performance can be improved.

### BRIEF DESCRIPTION OF THE DRAWINGS

FIG. 1 is a meridian cross-sectional view of a pneumatic tire according to an embodiment;

FIG. 2 is a plan view of a tread surface of the pneumatic tire according to the embodiment;

FIG. 3 is an enlarged plan view of the tread surface of the pneumatic tire according to the embodiment;

FIG. 4 is a schematic plan view of the tread surface of the pneumatic tire according to the embodiment;

FIG. 5 is a schematic plan view of the tread surface of the pneumatic tire according to the embodiment;

FIG. 6 is a schematic cross-sectional view of the tread surface of the pneumatic tire according to the embodiment;

FIG. 7 is a schematic cross-sectional view of the tread surface of the pneumatic tire according to the embodiment;

FIG. 8 is a table showing results of performance tests of pneumatic tires according to embodiments; and,

FIG. 9 is a table showing results of performance tests of pneumatic tires according to embodiments.

### DETAILED DESCRIPTION

An embodiment according to the present technology will be described in detail below with reference to the drawings. Note that the technology is not limited to the embodiment. Constituents of the embodiment include elements that are substitutable while maintaining consistency with the technology and obviously substitutable elements. A plurality of modified examples described in the embodiment can be combined as appropriate within the scope of obviousness to one skilled in the art.

In the following description, the term "tire radial direction" refers to a direction orthogonal to a tire rotation axis (not illustrated), which is a rotation axis of a pneumatic tire 1 according to an embodiment, the term "inner side in a tire radial direction" refers to a side toward the tire rotation axis in the tire radial direction, and the term "outer side in the tire radial direction" refers to a side away from the tire rotation axis in the tire radial direction. The term "tire circumferential direction" refers to a circumferential direction about the tire rotation axis as a center axis. The term "tire width direction" refers to a direction parallel with the tire rotation axis, the term "inner side in the tire width direction" refers to a side toward a tire equatorial plane (tire equator line) CL in the tire width direction, and the term "outer side in the tire width direction" refers to a side away from the tire equatorial plane CL in the tire width direction. The term "tire equatorial plane CL" refers to a plane that is orthogonal to the tire rotation axis and that passes through the center of a tire width of the pneumatic tire 1. The tire equatorial plane CL aligns, in a position in the tire width direction, with a center line in the tire width direction corresponding to a center position of the pneumatic tire 1 in the tire width direction. The term "tire equator line" refers to a line on the tire equatorial plane CL and in the tire circumferential direction of the pneumatic tire 1. The term "cross-section in the tire meridian direction (meridian cross-sectional view)" refers to a cross-section of the tire taken along a plane that includes the tire rotation axis.

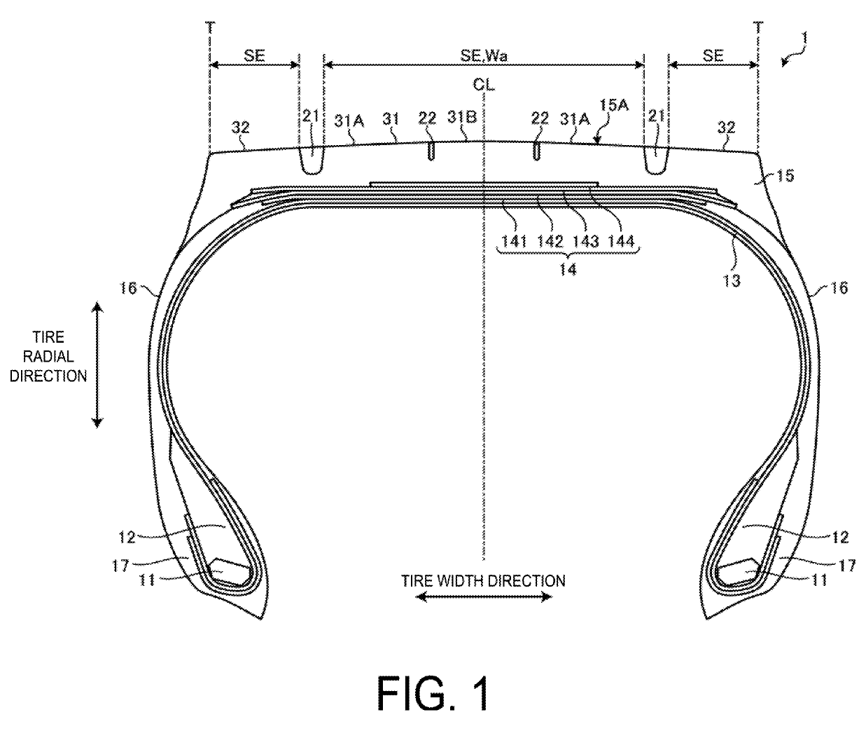

FIG. 1 is a meridian cross-sectional view of the pneumatic tire 1 according to an embodiment and illustrates a cross-section of a region on one side of the tire rotation axis in the tire radial direction. In the present embodiment, a heavy duty pneumatic radial tire mounted on a heavy load vehicle such as a truck or bus will be described as an example. The pneumatic tire 1 according to the present embodiment is particularly suitable for use as a tire to be mounted on a drive shaft of a heavy load vehicle.

The pneumatic tire 1 according to the embodiment has an annular structure with the tire rotation axis as its center, and as illustrated in FIG. 1, includes a pair of bead cores 11, a pair of bead fillers 12, a carcass layer 13, a belt layer 14, a tread rubber 15, a pair of sidewall rubbers 16, and a pair of rim cushion rubbers 17.

The pair of bead cores 11 include one or more bead wires made of steel and formed by being wound annularly multiple times, are embedded in bead portions, and constitute cores of the bead portions on both sides in the tire width direction.

The pair of bead fillers 12 are respectively disposed on an outer circumference of the pair of bead cores 11 in the tire radial direction and reinforce the bead portions.

The carcass layer 13 has a single-layer structure including one carcass ply or a multilayer structure including a plurality of carcass plies layered. The carcass layer 13 extends between the bead cores 11 in a toroidal shape, thereby forming a framework of the tire. Both end portions of the carcass layer 13 are turned back toward the outer side in the tire width direction and fixed to wrap the bead cores 11 and the bead fillers 12. The carcass ply of the carcass layer 13

is constituted by covering, with coating rubber, a plurality of carcass cords made of steel and by performing a rolling process on the carcass cords and has a cord angle (defined as an inclination angle in a longitudinal direction of the carcass cords with respect to the tire circumferential direction) of 80° or more and 90° or less as an absolute value for a radial tire and 30° or more and 45° or less for a bias tire.

The belt layer 14 is formed by layering a plurality of belt plies 141 to 144 and is disposed around an outer circumference of the carcass layer 13. The belt plies 141 to 144 include a large-angle belt 141, a pair of cross belts 142 and 143, and a belt cover 144. The large-angle belt 141 is constituted by covering, with coating rubber, a plurality of belt cords made of steel and by performing a rolling process on the belt cords and has a cord angle (defined as an inclination angle in a longitudinal direction of the belt cords with respect to the tire circumferential direction) of, for example, 45° or more and 70° or less as an absolute value. The pair of cross belts 142 and 143 are constituted by covering, with coating rubber, a plurality of belt cords made of steel and by performing a rolling process on the belt cords, and each have a cord angle of, for example, 10° or more and 55° or less as an absolute value. The pair of cross belts 142 and 143 have cord angles having mutually opposite signs and are layered such that the belt cords mutually intersect with each other in the longitudinal direction of the belt cords (a so-called crossply structure is formed). The belt cover 144 is constituted by covering, with coating rubber, a plurality of belt cover cords made of steel or an organic fiber material and by performing a rolling process on the belt cover cords and has a cord angle of, for example, 10° or more and 55° or less as an absolute value.

The tread rubber 15 is disposed on the outer circumference of the carcass layer 13 and the belt layer 14 in the tire radial direction and constitutes a tread portion of the pneumatic tire 1. In the tread portion, the tread rubber 15 constitutes a tread surface (tread contact surface) 15A on an outer circumferential surface that comes into contact with a road surface during travel.

The pair of sidewall rubbers 16 are each disposed on outer side of the carcass layer 13 in the tire width direction and constitute sidewall portions on both sides in the tire width direction.

The pair of rim cushion rubbers 17 extend from an inner side in the tire radial direction of the respective bead cores 11 and turned back portions of the carcass layer 13 toward the outer side in the tire width direction, and constitute rim fitting surfaces of the bead portions.

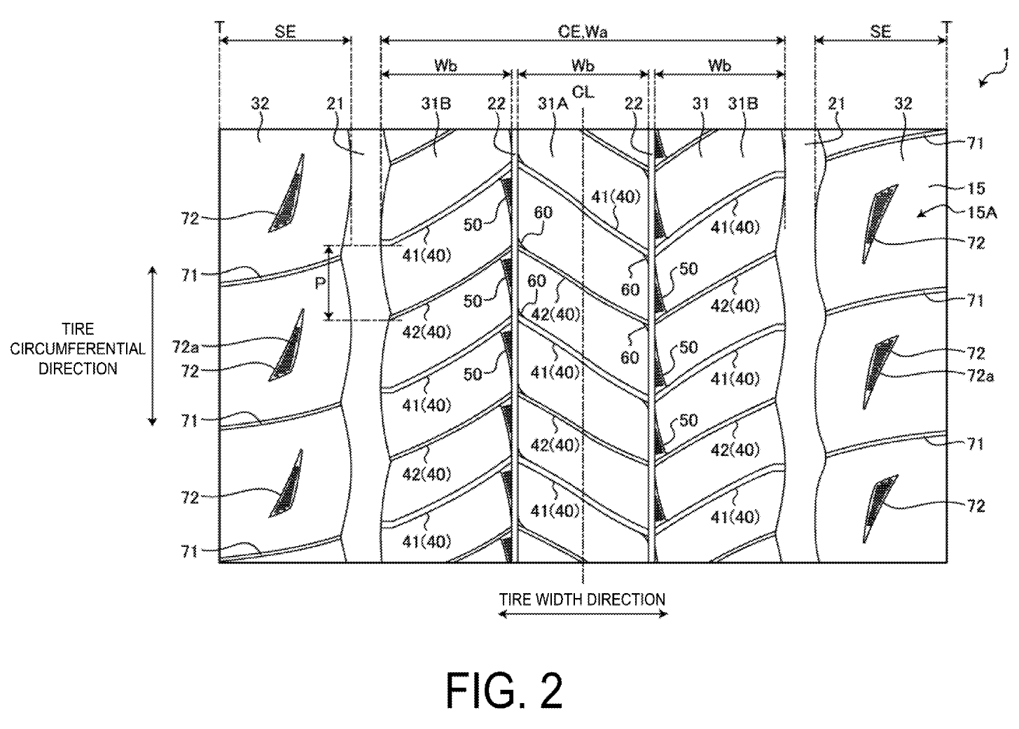

As illustrated in FIG. 2, the pneumatic tire 1 according to the embodiment includes a tread pattern on the tread surface 15A. Here, each dimension in the tread pattern is measured in a state where the tire is not mounted on a rim and a width between a pair of bead portions is set to a specified rim width.

"Specified rim" refers to a "standard rim" defined by the Japan Automobile Tyre Manufacturers Association, Inc. (JATMA), a "Design Rim" defined by the Tire and Rim Association, Inc. (TRA), or a "Measuring Rim" defined by the European Tyre and Rim Technical Organisation (ETRTO). "Specified internal pressure" refers to a "maximum air pressure" specified by JATMA, the maximum value in "TIRE LOAD LIMITS AT VARIOUS COLD INFLATION PRESSURES" specified by TRA, or "INFLATION PRESSURES" specified by ETRTO. "Specified load" refers to a "maximum load capacity" specified by JATMA, the maximum value in "TIRE LOAD LIMITS AT VARIOUS COLD INFLATION PRESSURES" specified by TRA, or "LOAD CAPACITY" specified by ETRTO.

A groove width (width) is measured as a maximum value of a distance between opposed groove walls of a groove opening portion on the tread contact surface in a state where the tire is not mounted on a rim and the width between the pair of bead portions is set to the specified rim width. In a configuration in which the groove opening portion includes a notch portion or a chamfered portion, the groove width (width) is measured by using, as end points, intersection points of an extension line of a tread contact surface and extension lines of the groove walls in a cross-section parallel with the tire width direction and the tire radial direction.

A groove depth (depth) is measured as a maximum value of a distance from the tread contact surface to a groove bottom in a state where the tire is not mounted on a rim and the width between the pair of bead portions is set to the specified rim width. In a configuration in which partial recessed and protruding portions are included at a groove bottom, the groove depth is measured excluding the partial recessed and protruding portions.

The pneumatic tire 1 includes circumferential main grooves 21, circumferential narrow grooves 22, width direction narrow grooves 40, chamfered portions 50, rounded chamfered portions 60, and shallow grooves 71 and 72 in the tread surface 15A.

The circumferential main grooves 21 each extend in the tire circumferential direction and include an annular structure disposed continuously over the entire circumference of the tire. At least two circumferential main grooves 21 are disposed side by side in the tire width direction with the tire equatorial plane CL interposed therebetween. As illustrated in FIG. 2, the circumferential main groove 21 may be formed in a zigzag shape that extends in the tire circumferential direction and meanders in the tire width direction. The circumferential main groove 21 has an opening to the tread surface 15A with a groove width (the narrowest width in the zigzag shape) of 10.0 mm or more and 18.0 mm or less and a groove depth of 10.0 mm or more and 26.0 mm or less from the tread surface 15A to a groove bottom. The circumferential main groove 21 is defined as a groove having a treadwear indicator as specified by JATMA mandatorily provided on the groove bottom.

In the pneumatic tire 1, the tread surface 15A is partitioned into a plurality of sections in the tire width direction with the circumferential main groove 21 as a boundary. Specifically, the pneumatic tire 1 according to the embodiment includes a center portion 31 defined between the two circumferential main grooves 21, and shoulder portions 32 each defined on an outer side of each circumferential main groove 21 in the tire width direction up to a ground contact edge T. The center portion 31 is disposed including the tire equatorial plane CL. The shoulder portions 32 are disposed respectively on both outermost sides of the tread surface 15A in the tire width direction.

Here, the ground contact edge T is defined as a maximum width position in the tire width direction of the contact surface between the pneumatic tire 1 and a flat plate when the pneumatic tire 1 is mounted on a specified rim, inflated to a specified internal pressure, placed perpendicular to the flat plate, and loaded with a load corresponding to a specified load.

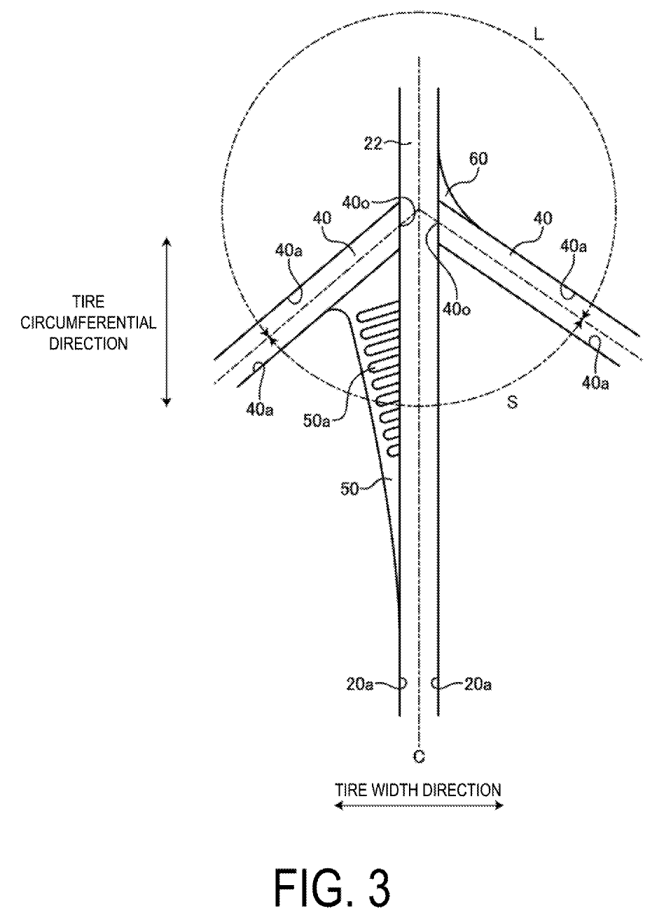

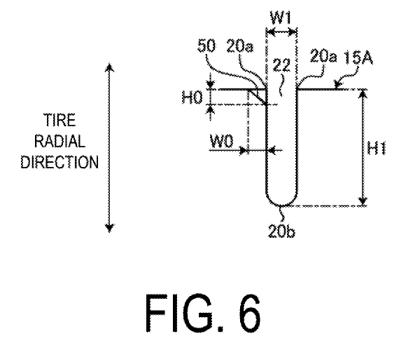

The circumferential narrow groove 22 extends in the tire circumferential direction in the center portion 31 and includes an annular structure disposed continuously over the entire circumference of the tire. At least one circumferential narrow groove 22 is disposed. In the embodiment, two circumferential narrow grooves 22 are disposed side by side in the tire width direction. The circumferential narrow groove 22 is formed in a linear shape in the tire circumferential direction. The circumferential narrow groove 22 has a groove width W1 (a distance of an interval of a groove opening portion 20a on the tread surface 15A: see FIGS. 3 and 6) of 1.0 mm or more and 3.0 mm or less, and a groove depth H1 (a distance from the tread surface 15A to a groove bottom 20b: see FIG. 6) of 8.0 mm or more and 26.0 mm or less. The circumferential narrow groove 22 has the groove width W1 formed to be small with respect to the circumferential main groove 21.

In the pneumatic tire 1, the center portion 31 is partitioned into a plurality of center land portions 31A and 31B arranged side by side in the tire width direction with the circumferential narrow grooves 22 as boundaries. Specifically, the pneumatic tire 1 includes one center land portion 31A defined between the circumferential narrow grooves 22 that are two circumferential narrow grooves 22, and two center land portions 31B each defined on an outer side of each circumferential narrow groove 22 in the tire width direction. In the pneumatic tire 1 according to the embodiment, the center land portion 31A is disposed at the center in the tire width direction, including the tire equatorial plane CL. In the pneumatic tire 1 according to the embodiment, each of the center land portions 31B is defined between the circumferential narrow groove 22 and

the circumferential main groove 21 that are located adjacent to each other in the tire width direction.

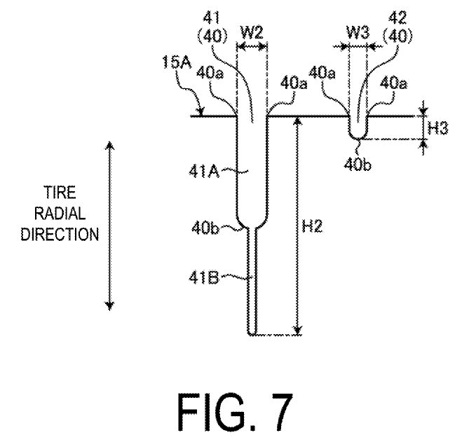

The width direction narrow groove 40 extends in the tire width direction in each of the center land portions 31A and 31B, both ends thereof are open to the circumferential main groove 21 and the circumferential narrow groove 22, and a plurality of the width direction narrow grooves 40 are arranged side by side in the tire circumferential direction. The width direction narrow groove 40 is formed in a linear shape or a curved line. As illustrated in FIG. 7, the width direction narrow groove 40 includes a first width direction narrow groove 41 having a relatively wide groove width W2 and a relatively deep groove depth H2, and a second width direction narrow groove 42 having a relatively narrow groove width W3 and a relatively shallow groove depth H3. The first width direction narrow groove 41 and the second width direction narrow groove 42 are disposed mixed in the tire circumferential direction in each of the center land portions 31A and 31B. In the pneumatic tire 1 according to the embodiment, the first width direction narrow groove 41 and the second width direction narrow groove 42 has a 2IN1 arrangement in which the first and second width direction narrow grooves are alternately arranged in the tire circumferential direction in each of the center land portions 31A and 31B. The first width direction narrow groove 41 includes a body portion 41A having a groove width W2, and a sipe 41B extending toward the inner side in the tire radial direction from a groove bottom 40b of the body portion 41A. The first width direction narrow groove 41 has a groove width W2 (a distance of an interval of a groove opening portion 40a of the body portion 41A on the tread surface 15A: see FIG. 7) of 1.5 mm or more and 3.0 mm or less (preferably 2.0 mm). The sipe 41B of the first width direction narrow groove 41 has a width of less than 1.0 mm. The first width direction narrow groove 41 has a groove depth H2 (a dimension from the tread surface 15A, including the body portion 41A and the sipe 41B: see FIG. 7) of 10.0 mm or more and 20.0 mm or less (preferably 14.5 mm). The first width direction narrow groove 41 is configured such that a ratio between the body portion 41A and the sipe 41B in the groove depth H2 is 40% or more and 60% or less (preferably 50%). The second width direction narrow groove 42 has a groove width W3 (a distance of an interval of the groove opening portion 40a on the tread surface 15A: see FIG. 7) of 1.0 mm or more and 2.0 mm or less (preferably 1.2 mm). The second width direction narrow groove 42 has a groove depth H3 (a dimension from the tread surface 15A to the groove bottom 40b: see FIG. 7) of 0.5 mm or more and 3.0 mm or less (preferably 1.5 mm). The width direction narrow grooves 40 (the first width direction narrow groove 41 and the second width direction narrow groove 42) are formed to have the groove widths W2 and W3 that are narrow with respect to the circumferential main groove 21.

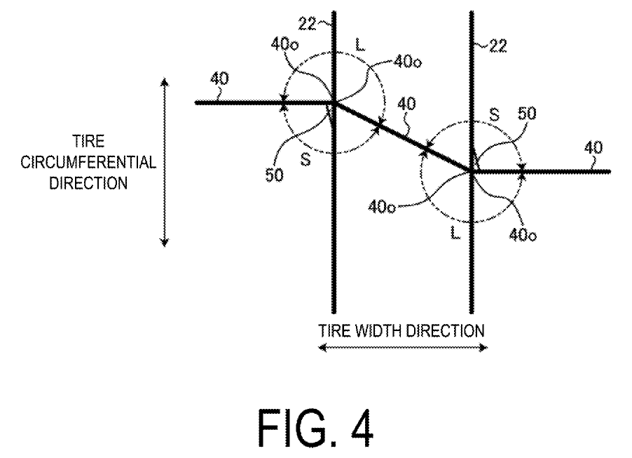

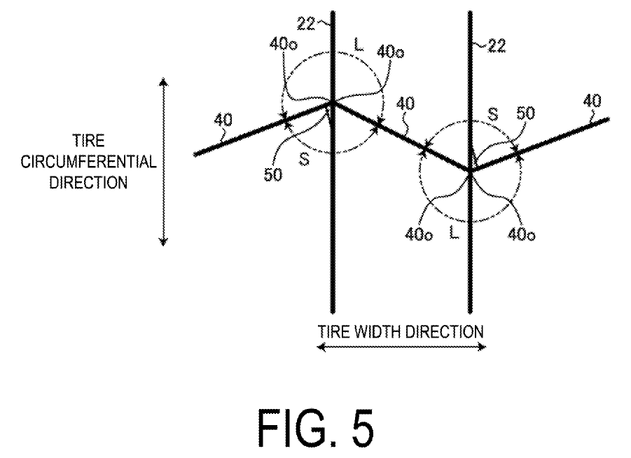

As illustrated in FIGS. 3 to 5, the width direction narrow grooves 40 are disposed such that openings 40o face each other via the circumferential narrow groove 22 as a boundary. In the pneumatic tire 1 according to the embodiment, the openings 40o of the first width direction narrow grooves 41 face each other, and the openings 40o of the second width direction narrow grooves 42 face each other. The width direction narrow grooves 40 whose openings 40o face each other are disposed changing an angle formed by the width direction narrow grooves 40 with respect to a center line C (a straight line passing through the center of the groove width W1: see FIG. 3) of the circumferential narrow groove 22 in a plan view as viewed in the tire radial direction and have a relationship of not being parallel to each other. The angle of the width direction narrow grooves 40 with respect to the center line C is measured with straight lines each connecting to an extension position from the opening 40o by 5% of the length of the width direction narrow groove 40. The width direction narrow grooves 40 whose the openings 40o face each other have the relationship of not being parallel to each other and thus form a high-angle side L and a low-angle side S in the range of angle of 360°formed by the width direction narrow grooves 40. The angle formed by the width direction narrow grooves 40 whose openings 40o face each other is less than 180° and preferably 100° or more and 160° or less at the low-angle side S.

As illustrated in FIG. 6, the chamfered portion 50 is formed so as to cut out the groove opening portion 20a of the circumferential narrow groove 22. As illustrated in FIGS. 3 to 5, the chamfered portion 50 is disposed from the groove opening portion 20a of the circumferential narrow groove 22 to the groove opening portion 40a of the width direction narrow groove 40 at the low-angle side S of the width direction narrow grooves 40 whose openings 40o face each other. Although the chamfered portions 50 may be disposed overlapping the width direction narrow grooves 40 whose openings 40o face each other, the chamfered portion 50 is preferably disposed overlapping one of the width direction narrow grooves 40 whose openings 40o face each other. In the pneumatic tire 1 according to the embodiment, the chamfered portion 50 is disposed on a portion on the circumferential main groove 21 side of the groove opening portion 20a in each circumferential narrow groove 22 located on the outermost side in the tire width direction. The chamfered portion 50 is configured such that a maximum width W0 with respect to the groove width W1 of the circumferential narrow groove 22 satisfies a relationship 0.5 ≤ W0/W1 ≤ 2.5 and that a maximum depth H0 with respect to the groove depth H1 of the circumferential narrow groove 22 satisfies a relationship 0.01 ≤ H0/H1 ≤ 0.15. The chamfered portion 50 has the maximum depth H0 of about 1.0 mm.

As illustrated in FIG. 3, a portion of the chamfered portion 50 overlapping the groove opening portion 40a of one of the width direction narrow grooves 40 whose openings 40o face each other has the maximum width W0 and the maximum depth H0 and is formed having a narrower width and a sallower depth as the chamfered portion 50 is away from the width direction narrow groove 40. The chamfered portion 50 is disposed along the groove opening portion 20a of the circumferential narrow groove 22 between the width direction narrow grooves 40 adjacent to each other in the tire width direction, and overlaps one of the adjacent width direction narrow grooves 40 but does not overlap the other of the adjacent width direction narrow grooves 40. The chamfered portion 50 is disposed along the groove opening portion 20a of the circumferential narrow groove 22 in a range of 70% or more and 100% or less with respect to one pitch P (see FIG. 2) between the width direction narrow grooves 40 adjacent to each other in the tire width direction. As illustrated in FIG. 3, the chamfered portion 50 is provided with a plurality of shallow and narrow grooves (also referred to as microgrooves) 50a on the surface thereof. The shallow and narrow grooves 50a are grooves each having, for example, a depth of 0.3 mm and a width of 0.6 mm. A plurality of the shallow and narrow grooves 50a are disposed side by side along the extension direction of the circumferential narrow groove 22 (the tire circumferential direction) and are each formed having a shorter length as the shallow and narrow grooves 50a are away from the width direction narrow groove 40.

As illustrated in FIGS. 2 and 3, the rounded chamfered portion 60 is disposed curved and recessed from the groove opening portion 20a of the circumferential narrow groove 22 to the groove opening portion 40a of the width direction narrow groove 40 at the high-angle side L of the width direction narrow grooves 40 whose openings 40o face each other. The rounded chamfered portion 60 may be disposed overlapping the width direction narrow grooves 40 whose openings 40o face each other but is preferably disposed overlapping one of the width direction narrow grooves 40 whose openings 40o face each other. In the pneumatic tire 1 according to the embodiment, when the chamfered portion 50 is disposed to overlap one of the width direction narrow grooves 40, the rounded chamfered portion 60 is disposed to overlap the other of the width direction narrow grooves 40. The rounded chamfered portion 60 is formed to have a width and a depth that are smaller than those of the chamfered portion 50. The rounded chamfered portion 60 has a radius of curvature R of 2 mm or more and 20 mm or less (preferably 7 mm).

The shallow grooves 71 and 72 are disposed in the tread surface 15A of the shoulder portion 32. The shallow grooves 71 each extend in the tire width direction, and one end thereof opens to the circumferential main groove 21 on the outermost side in the tire width direction and the other end thereof opens at the ground contact edge T. A plurality of the shallow grooves 71 are disposed side by side in the tire circumferential direction. The shallow groove 71 is disposed such that the opening faces the opening 40o of the width direction narrow groove 40 (the first width direction narrow groove 41 in the embodiment) via the circumferential main groove 21 as a boundary. The shallow groove 71 is formed in a linear shape or a curved shape. The shallow groove 71 has a groove width and a groove depth that are similar to those of the second width direction narrow groove 42. The shallow groove 71 is formed to have the groove width and the groove depth that are small with respect to the circumferential main groove 21.

The shallow groove 72 is disposed between the shallow grooves 71. The shallow groove 72 is formed as a recess recessed from the tread surface 15A. In the pneumatic tire 1 of the embodiment, the shallow groove 72 is formed as a triangular recess recessed from the tread surface 15A. The shallow groove 72 has a depth similar to that of the shallow groove 71. The shallow groove 72 is formed to have the depth that is shallow with respect to the circumferential main groove 21. The shallow groove 72 includes a plurality of shallow and narrow grooves (also referred to as microgrooves) 72a disposed on a bottom surface thereof. The shallow and narrow grooves 72a each have a depth of 0.3 mm, for example are disposed side by side in the tire circumferential direction.

The pneumatic tire 1 according to the embodiment described above includes: as its characteristics, in the tread surface 15A, at least two circumferential main grooves 21 extending in the tire circumferential direction; the center portion 31 defined between the circumferential main grooves 21 each located on the outermost side in the tire width direction; in the center portion 31, the circumferential narrow grooves 22 disposed extending in the tire circumferential direction and having a groove width narrower than those of the circumferential main grooves 21; in the center portion 31, the center land portions 31A and 31B defined by the circumferential main grooves 21 and the circumferential narrow grooves 22; in each of the center land portions 31A and 31B, the plurality of width direction narrow grooves 40 that are arranged side by side in the tire circumferential direction, each have both ends in the tire width direction opening to the circumferential main grooves 21 and the circumferential narrow grooves 22, are disposed changing an angle of each of the width direction narrow grooves 40 whose openings 40o face each other with the circumferential narrow grooves 22 as boundaries with respect to the center line C of each of the circumferential narrow grooves 22, and each have a groove width narrower than those of the circumferential main grooves 21; and in each of the center land portions 31A and 31B, the chamfered portions 50 disposed from at least one side of the groove opening portion 20a of each of the circumferential narrow grooves 22 to the groove opening portion 40a of each of the width direction narrow grooves 40 at the low-angle side S of the angle formed by the width direction narrow grooves 40 whose openings 40o face each other with the circumferential narrow grooves 22 as boundaries.

The pneumatic tire 1 causes, by disposing the circumferential narrow groove 22 in the center portion 31, the circumferential narrow groove 22 to close during ground contact to suppress deformation of the center portion 31, improving low rolling resistance. In addition, the pneumatic tire 1 have, by including the width direction narrow groove 40 and the chamfered portion 50, the groove opening portion of the circumferential narrow groove 22 and have drainage performance, allowing wet performance to be improved by the edge effect of the width direction narrow groove 40. The pneumatic tire 1 suppresses, by including the chamfered portion 50 at the low-angle side S formed by the width direction narrow grooves 40 whose openings 40o face each other, chipping of the tread surface 15A at the low-angle side S.

In the pneumatic tire 1 according to the embodiment, the width direction narrow groove 40 includes the first width direction narrow groove 41 having the relatively wide groove width W2 and the second width direction narrow groove 42 having the relatively narrow groove width W3, and in each of the center land portions 31A and 31B, the first width direction narrow groove 41 and the second width direction narrow groove 42 are disposed mixed in the tire circumferential direction.

The pneumatic tire 1 allows, by arranging the first width direction narrow groove 41 and the second width direction narrow groove 42 in a mixed manner (preferably alternately) in the tire circumferential direction, the rigidity of the center land portions 31A and 31B to be maintained, improving low rolling resistance and wet performance.

In the pneumatic tire 1 according to the embodiment, the width direction narrow groove 40 includes the first width direction narrow groove 41 having the relatively wide groove width W2, the relatively deep groove depth H2, and the sipe 41B on the groove bottom 40b, and the second width direction narrow groove 42 having the relatively narrow groove width W3 and the relatively shallow groove depth H3, and in each of the center land portions 31A and 31B, the first width direction narrow groove 41 and the second width direction narrow groove 42 are disposed mixed in the tire circumferential direction.

The pneumatic tire 1 allows, by arranging the first width direction narrow groove 41 and the second width direction narrow groove 42 in a mixed manner (preferably alternately) in the tire circumferential direction, the rigidity of the center land portions 31A and 31B to be maintained, improving low rolling resistance and wet performance. In addition, in the pneumatic tire 1, the sipe 41B closes at the groove bottom 40b during ground contact, and thus the first width direction narrow groove 41 ensures better drainage properties and improves wet performances.

In the pneumatic tire 1 according to the embodiment, the chamfered portion 50 is formed having the gradually narrowing width W0 and the gradually shallowing depth H0 as the chamfered portion 50 is away from the width direction narrow groove 40 along the circumferential narrow groove 22.

The pneumatic tire 1 can have a large gap and a large ground contact area ca on the tread surface on the width direction narrow groove 40 side during ground contact and improve wet performance in a well-balanced manner with respect to low rolling resistance.

In the pneumatic tire 1 of the embodiment, as illustrated in FIG. 2, a dimension Wa of the center portion 31 in the tire width direction, a dimension Wb of each of the center land portions 31A and 31B in the tire width direction, and the number A of circumferential narrow grooves 22 satisfy a relationship 0.7 ≤ Wb(A + 1)/Wa ≤ 1.0. Note that in the pneumatic tire 1 according to the embodiment, the circumferential main groove 21 has a zigzag shape, and in this case, the dimension Wb in the tire width direction is taken at the widest location in the tire width direction, ignoring the chamfered portion 50.

In the pneumatic tire 1, the width Wb of each of the center land portions 31A and 31B is 70% or more and less than 100% of the value obtained by equally dividing the width Wa of the center portion 31 by the number of center land portions 31A and 31B. By defining as just described, rigidity is constant in each of the center land portions 31A and 31B, and low rolling resistance is improved. To obtain the above effect, the pneumatic tire 1 preferably has the equally divided width Wb of each of the center land portions 31A and 31B.

In the pneumatic tire 1 according to the embodiment, as illustrated in FIG. 2, a dimension P of one pitch between the width direction narrow grooves 40 in the tire circumferential direction and the dimension Wb of the center land portion 31A, 31B in the tire width direction satisfy a relationship of 0.3 ≤ P/Wb ≤ 0.8.

In the pneumatic tire 1, by setting one pitch P between the width direction narrow grooves 40 in the tire circumferential direction to be within a specified range with respect to the dimension Wb of the center land portion 31A, 31B in the tire width direction. Thus, the rigidity of the center land portion 31A, 31B can be ensured and influence on low rolling resistance can be reduced while wet performance is improved by the arrangement of the width direction narrow grooves 40. To obtain the above effect, the pneumatic tire 1 preferably satisfies a relationship 0.4 ≤ P/Wb ≤ 0.7. Note that the pitch P between the width direction narrow grooves 40 in the tire circumferential direction includes a plurality of types (for example, three types of pitches).

In the pneumatic tire 1 according to the embodiment, the plurality of circumferential narrow grooves 22 are disposed in the center portion 31, and the chamfered portion 50 is disposed on a portion on the circumferential main groove 21 side of the groove opening portion 20a in each of the circumferential narrow grooves 22 located on the outermost side in the tire width direction.

In the pneumatic tire 1, by disposing the chamfered portion 50 on a portion on the circumferential main groove 21 side of the groove opening portion 20a in the circumferential narrow grooves 22, rigidity can be ensured and low rolling resistance can be further maintained on the center side of the center portion 31 in the tire width direction without including the chamfered portion 50, and wet performance can be improved on the outer side of the center portion 31 in the tire width direction.

In the pneumatic tire 1 according to the embodiment, the chamfered portion 50 includes the plurality of shallow and narrow grooves 50a disposed on the surface thereof.

In the pneumatic tire 1, providing the shallow and narrow groove 50a on the surface of the chamfered portion 50 increases the groove volume including the chamfered portion 50 and improves wet performance.

In the pneumatic tire 1 according to the embodiment, the center land portions 31A and 31B each include the rounded chamfered portion 60 disposed from at least one side of the groove opening portion 20a of the circumferential narrow groove 22 to the groove opening portion 40a of the width direction narrow groove 40 at the high-angle side L of the angle formed by the width direction narrow grooves 40 whose openings 40o face each other with the circumferential narrow grooves 22 as boundaries.

In the pneumatic tire 1, including the rounded chamfered portion 60 increases the groove volume in addition to providing the chamfered portion 50 and improves wet performance.

The pneumatic tire 1 according to the embodiment includes the shallow grooves 71 and 72 disposed in the shoulder portions 32 defined on the outer side in the tire width direction of the respective circumferential main grooves 21 located on the outermost side in the tire width direction.

In the pneumatic tire 1, disposing the shallow grooves 71 and 72 makes ground contact pressure uniform with the center portion 31 and improves low rolling resistance.

In the present embodiment, as described above, the pneumatic tire 1 is described as an example of a tire. The pneumatic tire 1 can be inflated with air, inert gas such as nitrogen, and other gases. However, the configuration of the tread pattern of the pneumatic tire 1 described in the present embodiment can also be applied to other tires within the scope apparent to one skilled in the art. Examples of other tires include an airless tire and a solid tire.

### Examples

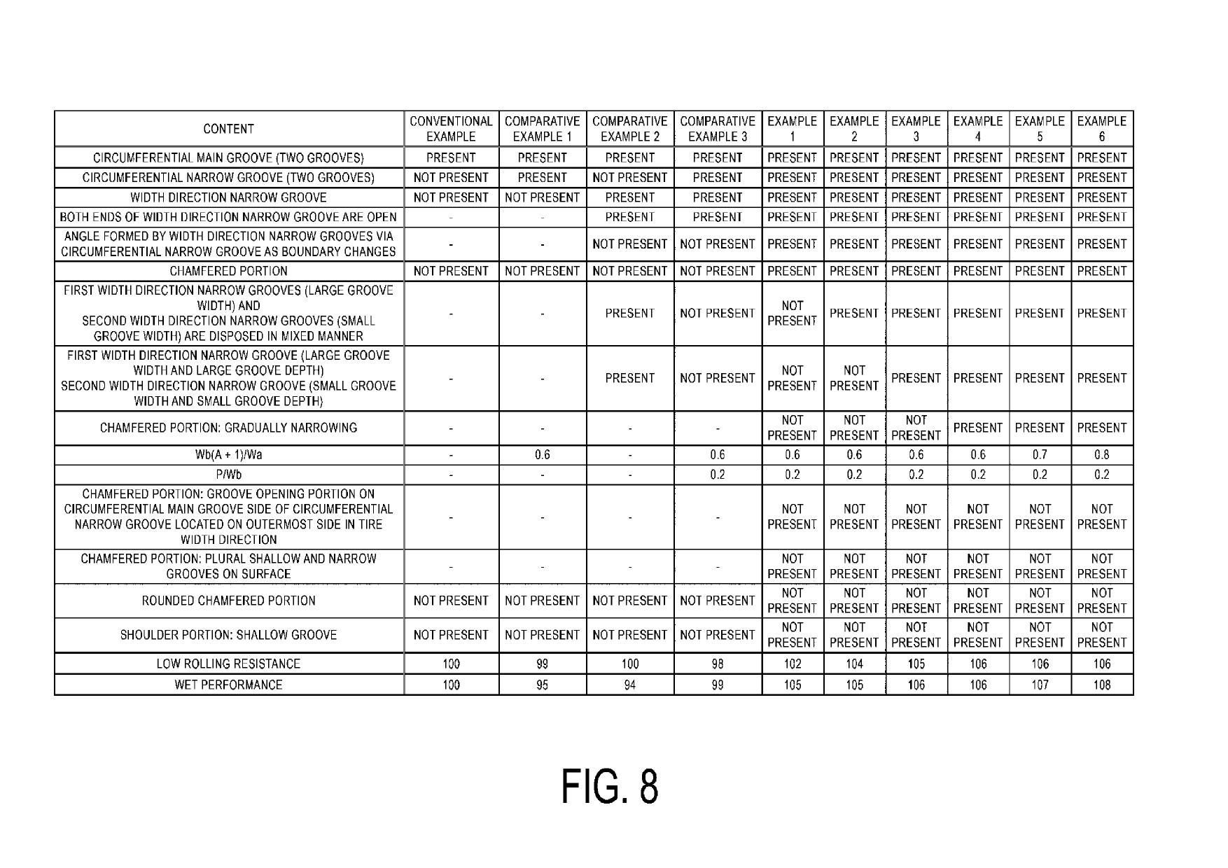

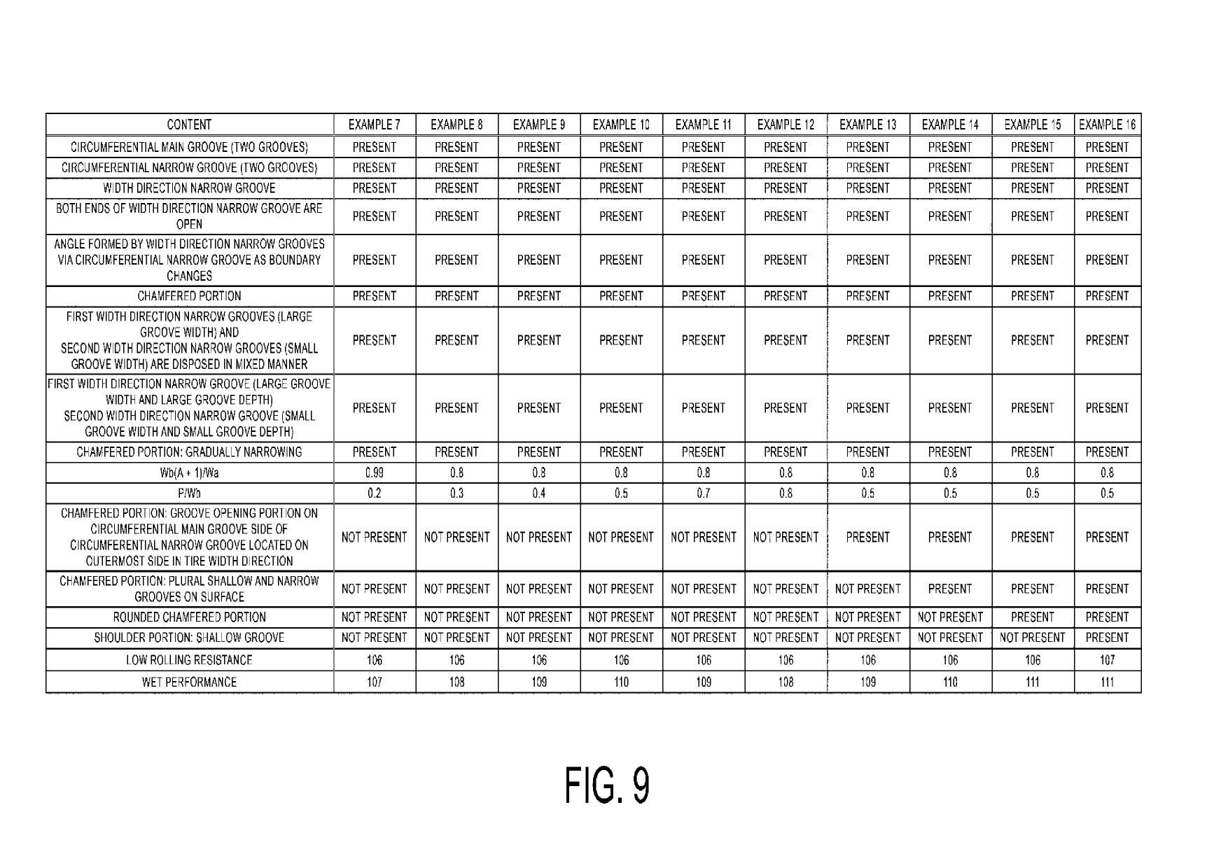

FIG. 8 and FIG. 9 are each showing results of performance tests of pneumatic tires according to embodiments. Hereinafter, performance evaluation tests conducted on pneumatic tires of Conventional Example, pneumatic tires of Comparative Examples, and pneumatic tires of Examples according to the embodiment will be described. For performance evaluation tests, tests on low rolling resistance and wet performance were performed.

In evaluation tests on low rolling resistance, pneumatic tires (test tires) having a tire size of 275/70R22.5 are mounted on a specified rim (22.5 × 8.25), inflated to a specified air pressure, and mounted on a heavy load vehicle, and a rolling resistance coefficient (ratio of rolling resistance to a load applied to the test tire) is measured under test conditions compliant with UN R117-04 (UN Regulation No. 117 Revision 4). On the basis of the measurement results, the evaluation is expressed as index values and evaluated with the reciprocal of Conventional Example being assigned as the reference (100). In the evaluation, larger values are preferable.

In evaluation tests on wet performance, pneumatic tires (test tires) having the above size are mounted on a specified rim, inflated to a specified air pressure, and mounted on a heavy load vehicle, and braking tests are performed on a wet surface with a water depth of 1 mm under test conditions compliant with UN R117-04 (UN Regulation No. 117 Revision 4) and a braking distance is measured. On the basis of the measurement results, the evaluation is expressed as index values and evaluated with the reciprocal of Conventional Example being assigned as the reference (100). In the evaluation, larger values are preferable.

The pneumatic tire of Conventional Example includes two circumferential main grooves illustrated in FIG. 2, but does not include a circumferential narrow groove and a width direction narrow groove, and thus does not include a chamfered portion.

The pneumatic tire of Comparative Example 1 includes two circumferential main grooves illustrated in FIG. 2, and two circumferential narrow grooves in a center portion, but does not include a width direction narrow groove and a chamfered portion. The pneumatic tire of Comparative Example 2 includes two circumferential main grooves illustrated in FIG. 2, and includes a width direction narrow groove while not including a circumferential narrow groove, but does not include a chamfered portion. The pneumatic tire of Comparative Example 3 includes two circumferential main grooves illustrated in FIG. 2, two circumferential narrow grooves in a center portion, and a width direction narrow groove, but does not include a chamfered portion.

The pneumatic tires of Examples each include two circumferential main grooves, two circumferential narrow grooves in a center portion, a width direction narrow groove, and a chamfered portion that are illustrated in FIG. 2.

As can be seen from the test results, in the pneumatic tires of Examples, low rolling resistance and wet performance are improved as compared with Conventional Example and Comparative Examples.

The present disclosure includes the following technologies.

### Technology 1

A tire, including:

in a tread surface,

at least two circumferential main grooves extending in a tire circumferential direction;

a center portion defined between the circumferential main grooves each located on an outermost side in a tire width direction;

in the center portion, circumferential narrow grooves disposed extending in the tire circumferential direction and each having a groove width narrower than those of the circumferential main grooves;

in the center portion, center land portions defined by the circumferential main grooves and the circumferential narrow grooves;

in each of the center land portions, a plurality of width direction narrow grooves that are arranged side by side in the tire circumferential direction, each have both ends in the tire width direction opening to the circumferential main grooves and the circumferential narrow grooves, are disposed changing an angle of each of the width direction narrow grooves whose openings face each other with the circumferential narrow grooves as boundaries with respect to a center line of each of the circumferential narrow grooves, and each have a groove width narrower than those of the circumferential main grooves; and,

in each of the center land portions, a chamfered portion disposed from at least one side of a groove opening portion of each of the circumferential narrow grooves to a groove opening portion of each of the width direction narrow grooves at a low-angle side of an angle formed by the width direction narrow grooves whose openings face each other with the circumferential narrow grooves as boundaries.

### Technology 2

The tire according to Technology 1, wherein the width direction narrow grooves each include a first width direction narrow groove having a relatively wide groove width and a second width direction narrow groove having a relatively narrow groove width, and in each of the center land portions, the first width direction narrow groove and the second width direction narrow groove are disposed mixed in the tire circumferential direction.

### Technology 3

The tire according to Technology 1, wherein the width direction narrow grooves each include a first width direction narrow groove having a relatively wide groove width and a relatively deep groove depth and including a sipe at a groove bottom and a second width direction narrow groove having a relatively narrow groove width and a relatively shallow groove depth, and in each of the center land portions, the first width direction narrow groove and the second width direction narrow groove are disposed mixed in the tire circumferential direction.

### Technology 4

The tire according to any one of Technologies 1 to 3, wherein the chamfered portion is formed having a gradually narrowing width and a gradually shallowing depth as the chamfered portion is away from the width direction narrow groove along the circumferential narrow groove.

### Technology 5

The tire according to any one of Technologies 1 to 4, wherein a dimension Wa in the tire width direction of the center portion, a dimension Wb in the tire width direction of each of the center land portions, and the number A of the circumferential narrow grooves satisfy a relationship 0.7 ≤ Wb/(A + 1)/Wa ≤ 1.0.

### Technology 6

The tire according to any one of Technologies 1 to 5, wherein in each of the center land portions, a dimension P of one pitch between the width direction narrow grooves in the tire circumferential direction and a dimension Wb in the tire width direction of each of the center land portions satisfy a relationship 0.3 ≤ P/Wb ≤ 0.8.

### Technology 7

The tire according to any one of Technologies 1 to 6, wherein a plurality of the circumferential narrow grooves are disposed in the center land portion, and the chamfered portion is disposed at a groove opening portion on a side of each of the circumferential main grooves in each of the circumferential narrow grooves located on the outermost side in the tire width direction.

### Technology 8

The tire according to any one of Technologies 1 to 7, wherein the chamfered portion includes a plurality of shallow and narrow grooves on a surface thereof.

### Technology 9

The tire according to any one of Technologies 1 to 8, including in each of the center land portions, a rounded chamfered portion disposed from at least one side of a groove opening portion of each of the circumferential narrow grooves to a groove opening portion of each of the width direction narrow grooves at a high-angle side of an angle formed by the width direction narrow grooves whose openings face each other with the circumferential narrow grooves as boundaries.

### Technology 10

The tire according to any one of Technologies 1 to 9, including a shallow groove disposed in a shoulder portion defined on an outer side in the tire width direction of each of the circumferential main grooves on the outermost side in the tire width direction.

1. A tire, comprising:
in a tread surface,
at least two circumferential main grooves extending in a tire circumferential direction;
a center portion defined between the circumferential main grooves each located on an outermost side in a tire width direction;
in the center portion, circumferential narrow grooves disposed extending in the tire circumferential direction and each having a groove width narrower than those of the circumferential main grooves;
in the center portion, center land portions defined by the circumferential main grooves and the circumferential narrow grooves;
in each of the center land portions, a plurality of width direction narrow grooves that are arranged side by side in the tire circumferential direction, each have both ends in the tire width direction opening to the circumferential main grooves and the circumferential narrow grooves, are disposed changing an angle of each of the width direction narrow grooves whose openings face each other with the circumferential narrow grooves as boundaries with respect to a center line of each of the circumferential narrow grooves, and each have a groove width narrower than those of the circumferential main grooves; and,
in each of the center land portions, a chamfered portion disposed from at least one side of a groove opening portion of each of the circumferential narrow grooves to a groove opening portion of each of the width direction narrow grooves at a low-angle side of an angle formed by the width direction narrow grooves whose openings face each other with the circumferential narrow grooves as boundaries.

2. The tire according to claim 1, wherein the width direction narrow grooves each comprise a first width direction narrow groove having a relatively wide groove width and a second width direction narrow groove having a relatively narrow groove width, and in each of the center land portions, the first width direction narrow groove and the second width direction narrow groove are disposed mixed in the tire circumferential direction.

3. The tire according to claim 1, wherein the width direction narrow grooves each comprise a first width direction narrow groove having a relatively wide groove width and a relatively deep groove depth and comprising a sipe at a groove bottom and a second width direction narrow groove having a relatively narrow groove width and a relatively shallow groove depth, and in each of the center land portions, the first width direction narrow groove and the second width direction narrow groove are disposed mixed in the tire circumferential direction.

4. The tire according to claim 1, wherein the chamfered portion is formed having a gradually narrowing width and a gradually shallowing depth as the chamfered portion is away from the width direction narrow groove along the circumferential narrow groove.

5. The tire according to claim 1, wherein a dimension Wa in the tire width direction of the center portion, a dimension Wb in the tire width direction of each of the center land portions, and the number A of the circumferential narrow grooves satisfy a relationship 0.7 ≤ Wb/(A + 1)/Wa ≤ 1.0.

6. The tire according to claim 1, wherein in each of the center land portions, a dimension P of one pitch between the width direction narrow grooves in the tire circumferential direction and a dimension Wb in the tire width direction of each of the center land portions satisfy a relationship 0.3 ≤ P/Wb ≤ 0.8.

7. The tire according to claim 1, wherein a plurality of the circumferential narrow grooves are disposed in the center land portion, and the chamfered portion is disposed at a groove opening portion on a side of each of the circumferential main grooves in each of the circumferential narrow grooves located on the outermost side in the tire width direction.

8. The tire according to claim 1, wherein the chamfered portion comprises a plurality of shallow and narrow grooves on a surface thereof.

9. The tire according to claim 1, comprising, in each of the center land portions, a rounded chamfered portion disposed from at least one side of a groove opening portion of each of the circumferential narrow grooves to a groove opening portion of each of the width direction narrow grooves at a high-angle side of an angle formed by the width direction narrow grooves whose openings face each other with the circumferential narrow grooves as boundaries.

10. The tire according to claim 1, comprising a shallow groove disposed in a shoulder portion defined on an outer side in the tire width direction of each of the circumferential main grooves on the outermost side in the tire width direction.
